(19) United States
(12) Patent Application Publication
(10) Pub. No.: US 2013/0196288 A1
(43) Pub. Date: Aug. 1, 2013

(54) DISTRACTION DEVICE FOR USE IN ORAL SURGERY

(71) Applicant: Peter Schleier, Hundvag (NO)

(72) Inventor: Peter Schleier, Hundvag (NO)

(73) Assignee: Stavanger Universitetssjukehus, Stavanger (NO)

(21) Appl. No.: 13/636,207

(22) PCT Filed: Mar. 22, 2011
(86) PCT No.: PCT/NO11/00096

§ 371 Date: Nov. 30, 2012

(30) Foreign Application Priority Data
Mar. 22, 2010 (NO) 20100422

(51) Int. Cl. A61C 8/02

(52) U.S. Cl. CPC A61C 8/0006
USPC 433/173

(57) ABSTRACT

A device for distraction in oral surgery comprises base plates (1, 2) which are affixable (can be fixed) to the jawbone by means of fixing screws (3, 4), and which are displaceable relative to one another with the aid of at least one activation cylinder (5). According to the invention, the fixing screws (3, 4) can be fixed by direct transmucosal insertion without exposure of the jawbone, and the base plates (1, 2) are arranged on the fixing screws at a distance from the jaw.

The present invention relates to a device for distraction in oral surgery, and more specifically it relates to a device for increasing the bone and mucosal volume of the alveolar ridge of the upper or lower jaw prior to tooth replacement by inserting, for example, titanium implants.

Replacement of missing teeth is desirable for both quality of life and prevention of malfunctions, such as, for example, when chewing. Traditionally, missing teeth have been replaced by prostheses or bridges. Today's solutions for tooth replacement involve the insertion of dental implants with direct fixation into the jawbone. However, the prerequisite for stable results then is that an adequate bone foundation is present.

Since the jawbone volume shrinks quite rapidly after tooth extraction, the adequate bone foundation that is absolutely necessary for a successful result is not present. Bone augmentation in the jaw is already an established method of treatment, but many problems occur in that the treatment per se is difficult as well as time-consuming and generates a risk of infection, and that donor bone, or bone replacement material, is required. Another disadvantage is that bone grafts often resorb or, put in another way, are eaten away after some months.

An alternative solution to this has been distraction osteogenesis, where new bone tissue is formed between two bone segments which are gradually separated from each other. This method has been utilised in cranial and facial surgery since 1989, for the purpose of extending the lower jaw. A normal healing process in that case is that after the bone separation a callus forms between the bone segments. If the reparation callus is then subjected to traction, this results in increased bone formation parallel to the direction of traction and consequently a bone extension. An additional effect is that adjustment reactions occur in the surrounding soft tissue. The advantage of distraction osteogenesis is that a gradual displacement stretches the soft tissue slowly, resistance is reduced and far greater bone volumes are obtained.

The use of vertical distraction treatment has not gained an established position in surgery for the building up of bone, and it is presumed that this is primarily due to three factors, i.e., it has resulted in minimal advantages over conventional techniques in hip bone grafting, the distraction equipment must be in place in the mouth for at least three months, which causes problems with eating, speaking and is per se bothersome, and it also involves complex and composite structures which require submucosal placement in direct contact with the jawbone, which results in distinct complications during use, such as bone resorption, local inflammation, swelling and pain.

Some typical examples of equipment suitable for vertical distraction are shown in US-A₁ 2003/0105463 and U.S. Pat. No.-B₂ 6,752,808, whilst US-A₁ 2003/0233093 relates to almost horizontal distraction of the jawbone. Although the last-mentioned document relates to placement against the gingivae, all are designed for fixation to the bone surface by means of moving parts which perforate the mucosa and which cause the disadvantages mentioned above. Another negative factor is that parts may only be replaced by surgical intervention, involving anaesthetic and other ordeals for the patient. Moreover, placement on the bone surface does not make minimal invasive surgery possible. The periodic adjustment of the spacing between the fixation structures contributes further to the complexity and discomfort for the patient. As regards the variant discussed in the last-mentioned document, an obvious drawback is that the mucous membrane is subjected to compression. This means that the mucous membrane will become necrotic and die of nutritional deficiency, which will result in inflammation and mucosal defects without the desired bone augmentation.

As suggested in the explanation above, there is clearly a need for better solutions in connection with the equipment for vertical distraction for increasing the bone and mucosal volume prior to tooth replacement.

According to the invention, there is therefore provided a device for distraction in oral surgery, comprising base plates which are affixed to the jawbone by means of fixing screws, and which are displaceable relative to one another with the aid of at least one activation cylinder, characterised in that the fixing screws are fixed by direct transmucosal insertion without exposure of the jawbone, and that the base plates are arranged on the fixing screws at a distance from the jaw.

For secure fixation, the base plates are secured to the fixing screws by means of angle-stable plate connectors. Similarly, the fixing screws may be of a length that is adapted to the jawbone substance in the region of the respective base plate.

Correct spacing between adjacent teeth is ensured in that at least the lower base plate has a width that is adapted to the desired spacing between these teeth.

To obtain a stabiliser effect, the activation cylinder can be locked at least on completed displacement of the base plates.

For increased stability during their mutual displacement, the base plates can be displaced by means of several activation cylinders. In that case, the activation cylinders are arranged close to their respective end area of the base plates.

This means that the distraction device can be placed with minimal surgical intervention, with a clear reduction in surgical risk and post-operative complications. As will be apparent, the installation is easy and parts can be swiftly replaced as required. The traditional complications such as infection, bleeding and bone resorption are also avoided. Nutrition of the bone is maintained, such that resorption in the potential augmentation area diminishes. The structure has a considerable potential for a modular design.

The invention will now be discussed in more detail with reference to the attached drawings.

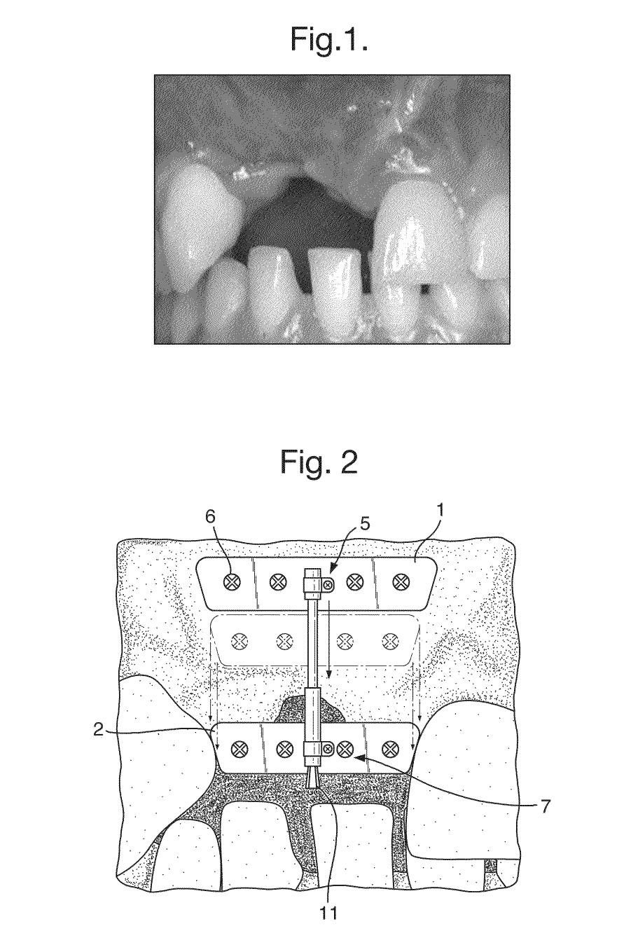

FIG. 1 is a photograph of an area of the jaw with missing teeth.

FIG. 2 is a front elevational view of the device for vertical distraction.

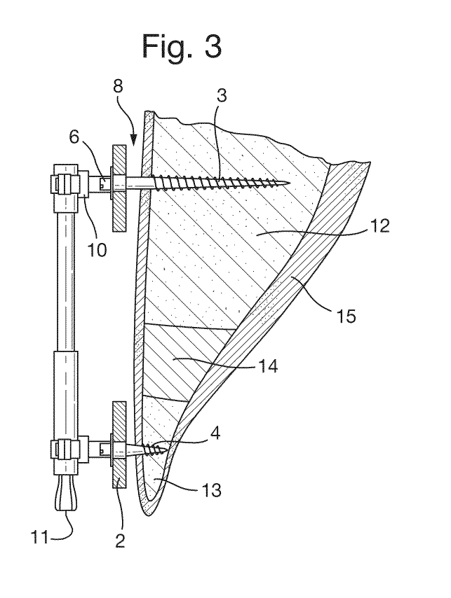

FIG. 3 shows that same as FIG. 2, but in a side view.

As shown in the drawings, the device for distraction in oral surgery according to the invention consists of three main components, specifically two base plates 1, 2, a plurality of fixing screws 3, 4, e.g., four for each base plate, and at least one activation cylinder 5. These components, and for that matter all others, are made of a suitable material, such as titanium. Furthermore, the unique aspect of the invention is that the fixing screws are fixed by direct transmucosal insertion without exposure of the jawbone, and that the base plates are arranged on the fixing screws at a distance from the jaw. Thus, the fixing screws can be placed merely by being “stuck” through the gum tissue and then screwed into the jawbone. Furthermore, the base plates are mounted at a sufficient distance for the establishment of a cleaning space 6 between the jaw and these two plates. See FIG. 3. Accessibility is therefore optimal, such that the mounting and subsequent adjustments of the distance between the base plates can take place without any additional interventions of a surgical nature.

It is further seen from the drawings that the connection between the base plates 1, 2 and each individual fixing screw 3, 4 is secured by means of angle-stable plate connectors 6, 7. See FIG. 4. These plate connectors may be of any suitable form. In a possible variant, each plate connector consists of an outer disc member of a larger diameter than the fixing screws and a threaded inner sleeve member which is inserted into a bore in the base plate, and which is screwed into corresponding threads on the adjacent end of the fixing screw, not shown in the drawings. Of course, it will be understood that the fixing screws are of a length that is adapted to the jawbone substance in the region of the respective base plate, i.e., the jawbone 7 itself and the separated and displaceable jawbone fragment 8.

As shown in FIG. 2, at least the base plate 2 facing the teeth has a width which is adapted to the desired spacing between adjacent teeth. By allowing the side edges on this base plate to slant inwards, the tooth spacing may be corrected if necessary. The base plates 1, 2 may also be used as a template for insertion of the fixing screws 3, 4 in the jawbone before detachment of the jawbone fragment that is to be displaced for formation of the distraction callus 9. The inner sleeve member in each plate connector 6, 7 may be designed such that a clamping effect against the respective bore in the base plate 1, 2 is obtained. In this way, a stable fixation of the base plates 1, 2 on the fixing screws is obtained, not illustrated. Another alternative is use of external threads which correspond to internal threads in the base plate bore. Neither of the two alternatives should be understood as limiting, but merely as examples of a multitude of possibilities.

The at least one activation cylinder 5 can be attached to the base plates in any suitable manner. This is shown schematically in the drawings with a connecting unit 10 at each end of the activation cylinder in the form of a ring clip that is fastened by a screw or the like. The spacing between the base plates during distraction can be effected in many ways, e.g., with the illustrated adjusting screw 11. Thus, the two cylinder parts of the activation cylinder 5 can be mutually displaced from one another. Although it is not shown in more detail, the at least one activation cylinder 5 is lockable incrementally or upon completed displacement of the base plates 1, 2 in order to act almost as a stabiliser. A possible solution is then that the two cylinder parts are equipped with a pin-and-slot connection that can be pushed in and out of engagement with each other in the displacement levels in question. Improved stability during distraction can be obtained in that the base plates 1, 2 are mutually displaceable with the aid of several activation cylinders, not shown. It is in that case most expedient that the activation cylinders are arranged preferably close to their respective end area of the base plates.

The actual important process of fragmenting the jawbone 12 with detachment of the displaceable bone fragment 13 for formation of the distraction callus 14 and extension of the surrounding gingiva 15 of mucous membrane and soft tissue will be known to the skilled person, and any further discussion of this process here should therefore be unnecessary.

However, as can also be seen from FIGS. 2 and 3, a method for use of the distraction device according to the invention will be able to comprise the features of: arranging the base plates 1, 2 at a distance from the jawbone; affixing the base plates 1, 2 to the jawbone by means of fixing screws 3, 4 by direct transmucosal insertion of the fixing screws without exposure of the jawbone; and displacing the base plates 1, 2 relative to one another by adjusting the activation cylinder 5 after separation of a bone fragment 12 from the jaw 12, the jaw 12 and the jaw fragment 13 being affixed to their respective base plate 1, 2.

1. A device for distraction in oral surgery, comprising:
base plates which are affixable to the jawbone by means of fixing screws and which are displaceable relative to one another with the aid of at least one activation cylinder;
wherein the fixing screws are affixable by direct transmucosal insertion without exposure of the jawbone; and
wherein the base plates are arranged on the fixing screws at a distance from the jaw.

2. The device according to claim 1, wherein the base plates are secured to the fixing screws by means of angle-stable plate connectors.

3. The device according to claim 1, wherein the fixing screws have a length that is adapted to the jawbone substance in the region of the respective base plate.

4. The device according to claim 1, wherein at least the base plate facing the teeth has a width that is adapted to the desired spacing between adjacent teeth.

5. The device according to claim 1, wherein the activation cylinder is lockable incrementally or upon completed displacement of the base plates.

6. The device according to claim 1, wherein the base plates are displaceable relative to one another with the aid of several activation cylinders.

7. The device according to claim 6, wherein the activation cylinders are arranged close to their respective end area of the base plates.
